(19) United States
(12) Patent Application Publication
(10) Pub. No.: US 2017/0199834 A1
(43) Pub. Date: Jul. 13, 2017

(54) VEHICLE SUBSYSTEM COMMUNICATION ARBITRATION

(71) Applicant: Ford Global Technologies, LLC, Dearborn, MI (US)

(72) Inventors: John P. Joyce, West Bloomfield, MI (US); Scott J. Lauffer, Northville, MI (US)

(73) Assignee: Ford Global Technologies, LLC, Dearborn, MI (US)

(21) Appl. No.: 14/994,448

(22) Filed: Jan. 13, 2016

(51) Int. Cl. G06F 13/40; G06F 13/42; G06F 13/364

(52) U.S. Cl. CPC G06F 13/4031; G06F 13/364; G06F 13/4282

(57) ABSTRACT

A vehicle subsystem includes a first signal including a first master value is transmitted from a first failsafe device and a third failsafe device. A first, signal is transmitted via a primary bus. A second signal including a second master value is transmitted from a second failsafe device to a fourth failsafe device. The first and second master values indicate whether the first and second signals are authoritative on the primary bus, the secondary bus, both, or neither.

### BACKGROUND

An autonomous vehicle, i.e., a vehicle in which some or all operations conventionally controlled by a human operator are controlled and carried out by components in the vehicle without operator intervention, depends upon maintaining and coordinating key subsystem functions in the event of a failure.

### BRIEF DESCRIPTION OF THE DRAWINGS

FIG. 1 illustrates an example vehicle including an example vehicle arbitration system.

FIG. 2 is a block diagram of the example vehicle arbitration system.

FIG. 3 is a process flow diagram of an example process for arbitrating signals in a failsafe device.

FIG. 4 is a chart of arbitration logic used in the process of FIG. 2.

### DETAILED DESCRIPTION

Failures for autonomous and non-autonomous vehicles could include power failures, communication failures, and failures of logic devices. Present mechanisms are lacking for addressing failures of subsystems and coordinating redundant logic and communication during a failure, especially in the context of autonomous vehicles.

In an autonomous or non-autonomous vehicle, fail-functional behavior may help mitigate issues caused by the failure. In a conventional vehicle, most electronically controlled systems that support driver control of the vehicle fail-safe reduce support for driver control, but by doing so assure that they do not interfere with driver control. In an autonomous vehicle, however, the electronically controlled systems may provide the primary control of the vehicle. When failures occur, there may be no driver controlling the vehicle, so the electronically controlled systems must maintain a significant level of function, at least until the driver can assume manual control.

One way to overcome such issues is with vehicle subsystem communication arbitration. A system within a vehicle may include multiple logic devices in communication with counterpart devices in other systems in the vehicle. The system for arbitrating such communications includes first and second failsafe devices, each failsafe device having a processor and a memory. The memory stores instructions executable by the processor to transmit information. The system further includes a first arbitration bus connecting he first and second failsafe devices. The first arbitration bus transmits information between the first and second failsafe devices. The first failsafe device is programmed to communicate with a third failsafe device over a primary bus. The second failsafe device is programmed to communicate with a fourth failsafe device over a secondary bus. The first failsafe device is programmed to transmit a first signal including a first master value to the second failsafe device via a first network path. The first network path includes the first arbitration bus. The first failsafe device is programmed to transmit a first signal including a first master value via a second network path. The second network path includes the primary bus and the secondary bus and a second arbitration bus connecting the third and fourth failsafe devices and transmitting information between the third and fourth failsafe devices. The first master value indicates one of whether the first signal is authoritative on the primary bus, the secondary bus, both the primary and secondary busses, or neither bus. The term “authoritative” may refer to whether signals from a particular bus are considered reliable by the failsafe devices, i.e., if a master value indicates that a signal is authoritative on a primary bus, then the failsafe device will consider the signals received on the primary bus as accurate, and if the master value indicates that a signal is not authoritative on a secondary bus, then the failsafe device will consider signals received from the secondary bus as potentially inaccurate until the failsafe device receives an indication, e.g., another master value, that signals are authoritative on the secondary bus. In other words, the term “authoritative” may indicate whether the signal should be trusted by the failsafe device that receives the signal.

With reference to the Figures, the elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

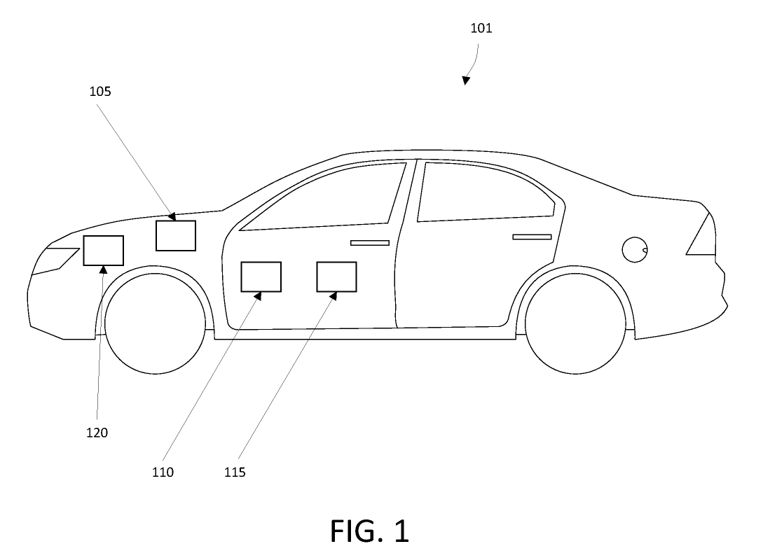

FIG. 1 illustrates a vehicle 101. The vehicle 101 includes multiple subsystems, including an autonomous subsystem 105, a powertrain subsystem 110, a brake subsystem 115, and a steering subsystem 120. The vehicle 101 may be, e.g., a car, a truck, and/or any other suitable vehicle. The subsystems, such as the autonomous operation subsystem 105 including first and second failsafe devices 106, 107, may incorporate a combination of software and hardware for performing various operations. For example, each of the failsafe devices 106, 107 may be programmed for receiving and processing sensor data, receiving and processing data from various vehicle 101 components, and for providing information and instructions to various vehicle 101 components to support various autonomous actions, i.e., vehicle 101 operations performed without intervention or controlled by a human operator. Accordingly, each of the devices 106, 107 generally includes multiple processors and a memory, the memory including one or more forms of computer readable media, and storing instructions executable by the processor for performing various operations, including as disclosed herein, whereby the subsystem 105 includes programming for conducting various operations. Further, each of the devices 106, 107 is constructed with redundant components, monitoring functions, and programming that render it capable of detecting failures within itself and completely disabling or substantially reducing its function in the event a failure is detected.

The autonomous subsystem 105 may be programmed to operate the vehicle 101 with limited or no input from a human operator. The autonomous subsystem 105 may include a first failsafe device 106 and a second failsafe device 107. The autonomous subsystem 105 may be communicatively coupled to other subsystems 110, 115, 120 via a communications bus 130, 131.

The failsafe devices 106, 107 may be programmed to react to internal faults or failures, faults or failures in each other, and faults or failures in other subsystems. Each of the failsafe devices 106, 107 may include internal failure-handling mechanisms, e.g., multiple microprocessors or other mechanisms for independently executing programming for carrying out operations of a respective other failsafe device 106, 107. For example, first and second microprocessors in a failsafe device 106 or 107 could generate a result and compare their results with one another. If the results did not match, the device 106 or 107 could declare a fault and cease operations, send a notification to another device 106, 107 relating to the fault, etc.

The vehicle 101 may include a powertrain subsystem 110. The powertrain subsystem 110 may be programmed to receive instructions from the autonomous subsystem 105 to control a vehicle 101 powertrain. The powertrain subsystem 110 may include failsafe devices 111, 112. The powertrain subsystem 110 may be communicatively coupled to the autonomous subsystem 105 and other subsystems 115, 120 via the communications bus 130, 131.

The vehicle 101 may include a brake subsystem 115. The brake subsystem 115 may be programmed to receive instructions from the autonomous subsystem 105 to control a vehicle 101 brake. The brake subsystem 115 may include failsafe devices 116, 117. The brake subsystem 115 may be communicatively coupled to the autonomous subsystem 105, the powertrain subsystem 110, and other subsystem 120 via the communication bus 130, 131.

The vehicle 101 may include a steering subsystem 120. The steering subsystem 120 may be programmed to receive instructions from the autonomous subsystem 105 to steer the vehicle 101. The steering subsystem 120 may include failsafe devices 121, 122. The steering subsystem 120 may be communicatively coupled to the autonomous subsystem 105, the powertrain subsystem 110, and the brake subsystem 115 via the communication bus 130, 131.

The subsystems 105, 110, 115, 120 may be powered by power sources 125, 126. The power sources 125, 126 provide power to the subsystems 105, 110, 115, 120, including the failsafe devices 106, 107, 111, 112, 116, 117, 121, 122. The power source 125 may be coupled to the subsystems 105, 110, 115, 120 via a power coupling 127, and the power source 126 may be coupled to the subsystems 105, 110, 115, 120 via a power coupling 128.

The vehicle 101 may include communication buses 1.30, 131. The buses may be, e.g., one or more mechanisms for network communications in the vehicle 101, e.g., a controller area network (CAN) bus, which, by way of example and not limitation, may be configured for communications as controller area network (CAN) buses or the like, and/or may use other communications mechanisms and/or protocols, may be used to provide various communications, including data between the subsystems 105, 110, 115, 120.

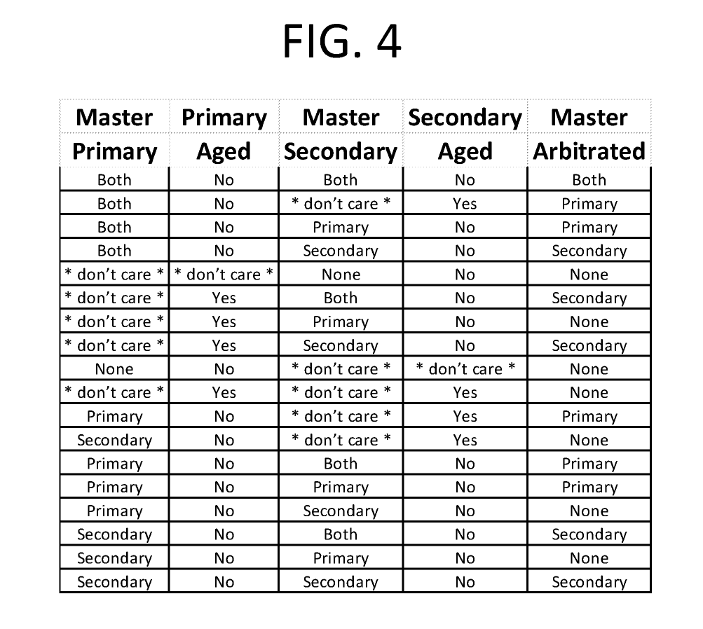

The vehicle 101 may include an arbitration bus 135. An arbitration bus is defined for purposes of this disclosure as a communications connection or link between two failsafe devices in a vehicle 101 subsystem, as well as programming in at least one of the devices, and/or in a microprocessor of the bus 135 itself, for implementing logic to determine an action. For example, the arbitration bus may implement logic to determine an action to take upon detecting a fault or failure. “Arbitration” is defined as implementing logic, e.g., the example logic of FIG. 4, to determine an action.

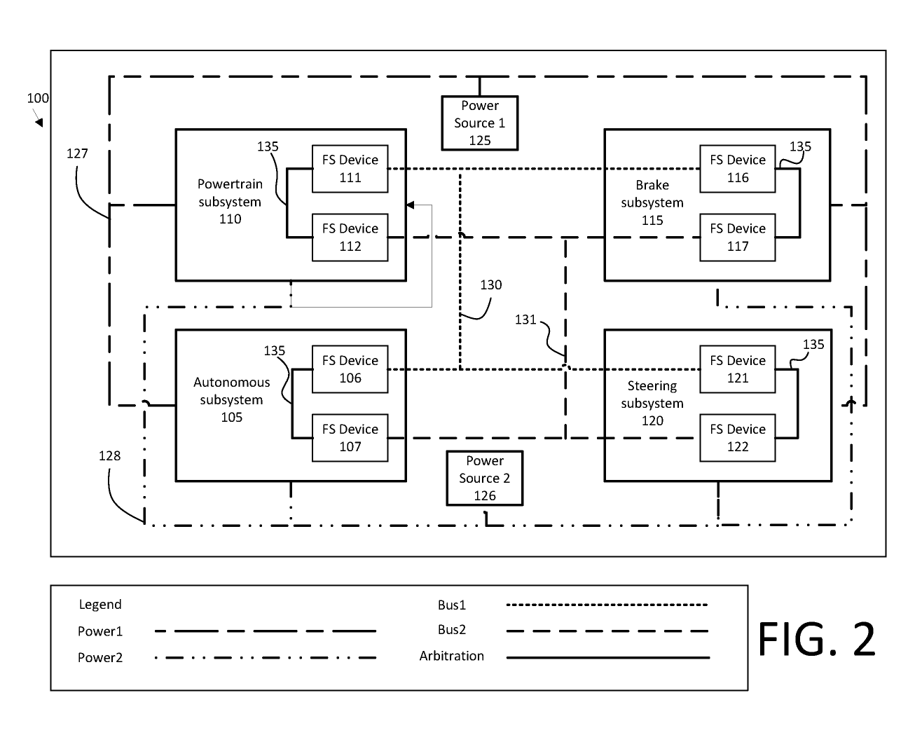

FIG. 2 is a block diagram of an example vehicle arbitration system 100 in an autonomous host vehicle 101. The autonomous subsystem 105 is connected to first and second power sources 125, 126, as well as first and second communications buses 130, 131. Via the buses 130, 131, and/or other wired and/or wireless mechanisms, the subsystem 105 may transmit messages to various devices or subsystems in a vehicle 101, and/or receive messages from the various devices, e.g., controllers, actuators, sensors, etc.

Via the buses 130, 131 the autonomous subsystem 105 is in communication with various vehicle 101 components, including a powertrain subsystem 110, a brake subsystem 115, or a steering subsystem 120, and or other subsystems, such as a vehicle 101 lighting control subsystem (not shown). Each of the subsystems 110, 115, and 120, like the autonomous operation subsystem 105, comprise respective failsafe devices 111, 112, 116, 117, 121, and 122, each of which includes a combination of software and hardware, i.e., a processor, and a memory storing instructions executable by the processor, for performing operations including those described herein as well as other operations. For example, the powertrain subsystem 110 includes devices 111, 112 that are generally programmed to perform operations for controlling a vehicle 101 powertrain, the brake subsystem 115 includes devices 115 that may be programmed to perform operations for controlling vehicle 101 brakes, the steering subsystem 120 includes devices 121, 122 that may be programmed to perform operations for controlling vehicle 101 steering, etc. As with the devices 106, 107 described above, each of the devices 111, 112, 116, 117, 121, and 122 is generally constructed with redundant components, monitoring functions, and programming that render it capable of detecting failures within itself and completely disabling or substantially reducing its function in the event a failure is detected.

The failsafe devices 106, 107 are each programmed to react to information provided by other subsystems. Moreover, each of the failsafe devices 106, 107 may generate information to send to the failsafe devices in the other subsystems. For example, first and second microprocessors in a failsafe device 106 or 107 could each generate a master value and send the master value over the communication buses 130, 131 to the other failsafe devices 111, 112, 116, 117, 121, and 122. The “master value” is defined as information indicating whether a signal is authoritative on both, neither, or only one of the buses 130, 131. The master value may be separate from the output of the failsafe devices 106, 107 111, 112, 116, 117, 121, 122.

Each failsafe device 106, 107, as mentioned above, is further programmed to perform independently operations of the subsystem 105, although one or both of the failsafe devices 106, 107 may not perform all operations of the subsystem 105 and/or may not perform operations of the subsystem 105 as quickly or efficiently as the subsystem 105. Each of the failsafe devices 106, 107 is connected to one of the communications buses 130, 131, e.g., as seen in FIG. 1, the failsafe device 106 is connected to the first communications bus 130, and the second failsafe device 107 is connected to the second communications bus 131.

Each of the subsystems 110, 115, and 120 has an architecture similar to that just described of the subsystem 105. For example, the powertrain subsystem 110 includes or is communicatively coupled to first and second failsafe devices 111, 112, the devices 111, 112 being connected to buses 1.30, 131, respectively. The brake subsystem 115 includes or is communicatively coupled to failsafe devices 116, 117, connected to the buses 130, 131 respectively. The steering subsystem 120 includes or is communicatively coupled to failsafe devices 121, 122, connected to the buses 130, 131 respectively. The failsafe devices 111, 112, 116, 117, 121, 122 further generally include internal failure handling mechanisms such as discussed above with respect to the devices 106, 107. Moreover, each failsafe device in one of the respective pairs of devices 111 and 112, 116 and 117, as well as 121 and 122, may be connected to a same and/or different actuators, e.g., to provide instructions for performing operations of the subsystem 110, 115, or 120, such as controlling a vehicle 101 powertrain, brakes steering, etc.

Further, the subsystems 110, 115, and/or 120 may include other failsafe devices, power connections, and communication connections, in addition to those shown in FIG. 2. For example, the powertrain subsystem 110 in particular may warrant further redundancy and/or provide alternative or additional failover options, such as a “coast down” mode in the event of a powertrain subsystem 110 failure. Moreover, the autonomous operation subsystem 105 may include additional failsafe devices, power connections, and communication connections in addition to those shown therein.

The subsystems 105. 110, 115, 120 further include at least one arbitration bus 135 between failsafe devices. In the example of FIG. 2, an arbitration bus 135 is provided in or between the failsafe devices 106, 107 of the autonomous subsystem 105. Each pair of failsafe devices in each subsystem similarly includes its own arbitration bus 135. For example, the powertrain subsystem 110 includes an arbitration bus 135 between the failsafe devices 111, 112, the brake subsystem 115 includes an arbitration bus 135 between the failsafe devices 116, 117, and the steering subsystem 120 includes an arbitration bus 135 between the failsafe devices 121, 122. The arbitration bus 135 includes programming for determining which of the two communications buses 130, 131 to use for communications with various vehicle 101 subsystems 105, 110, 115, 120, etc.

The arbitration technique employed by the various failsafe devices 106, 107, 111, 112, 116, 117, 121, 122 may detect a master value in or associated with one of the buses 130, 131 in a variety of ways. For example, in one scenario, the bus 130 may be a primary communications bus, and the bus 131 may be a backup, or secondary communications bus. In this scenario, the device 106 could receive a master value or the like via one of the bus 130 from a one of the subsystems 110, 115, or 120. The device 106 could then indicate via the arbitration bus 135 to its counterpart device 107 of the master value in the bus 130. Similarly, the device 107 may receive another master value from the secondary bus 131 via the bus 130 and a second arbitration bus 135 connecting another pair of failsafe devices, e.g., failsafe devices 111, 112. If the master value received from the bus 130 differs from the master value received from the bus 131, the autonomous operation subsystem 105 could apply arbitration logic, as described below, to determine the authority of the master values.

In general, an arbitration bus 135 such as illustrated in FIG. 2 in the autonomous subsystem 105 depends upon programming devices 106, 107 to process communications indicating a master value from the various subsystems 110, 115, 120, etc. Such programming will depend on a knowledge of communications and program logic implemented in the various subsystems 110, 115, 120, etc. For example, the devices 106, 107 may recognize master values or the like provided from the various subsystems 110, 115, 120.

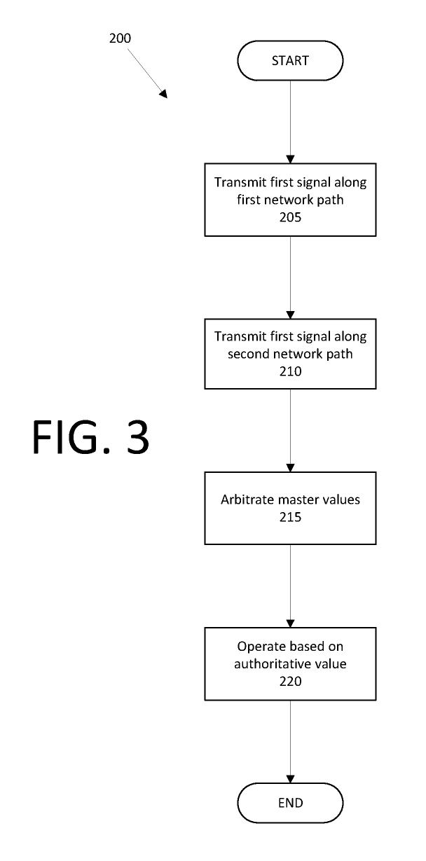

FIG. 3 illustrates a process 200 for arbitrating values received h failsafe devices. The process 200 begins in a block 205, where a first failsafe device, e.g., the failsafe device 106, may transmit a first signal to a second failsafe device, e.g., the failsafe device 107 along a first network path. The first signal may include a first master value indicating whether the first signal is authoritative on both, neither, or only one of the communication buses 130, 131. The first network path includes a first arbitration bus 135.

Next, in a block 210, the first failsafe device 106 may transmit the first signal along a second network path. The second network path includes a primary bus, e.g., the bus 130, connecting a third failsafe device, e.g., the failsafe device 111, to the first failsafe device 106, a fourth failsafe device, e.g., the failsafe device 112, connected to the third failsafe device 111 a second arbitration bus 135 connecting the third and fourth failsafe devices 111, 112, and a secondary bus, e.g., the bus 131, connecting the fourth failsafe device 112 to the second failsafe device 107.

Next, in a block 215, the subsystem 105 may arbitrate the master values from the first signals sent along the first and second network paths. If one of the failsafe devices and/or one of the communications busses fails, the master value may differ or one of the master values may be “aged,” i.e., sent longer ago than a specified period of time, e.g., 10 ms. The second failsafe device 107 thus arbitrates the two master values to determine whether the first signal is authoritative on both, none, or only one of the primary and secondary buses 130, 131. The master values are arbitrated according the arbitration logic discussed in FIG. 4 below.

Next, in the block 220, the subsystem 105 operates according to the authoritative master value. For example, if the arbitration determines that the first signal is authoritative only on the primary bus 130, then the subsystem 105 will operate based on information collected only from the primary bus 130. In another example, if the master value from the primary bus 130 is aged, then the subsystem 105 will operate based on information from the secondary bus 131.

In another example, a second signal including a second master value sent from the second failsafe device 107 to the first failsafe device 106 via a first network path including the arbitration bus 135 and a second network path including the secondary bus 131, the fourth failsafe device 112, the second arbitration bus 135, the third failsafe device 111, and the primary bus 130. In yet another example, the first failsafe device 106 may receive a third signal including a third master value from the third failsafe device 111 via a first network path that includes the primary bus 130 and a second network path that includes the first and second arbitration buses 135, the secondary bus 131, and the second and fourth failsafe devices 106, 112. The second and third master values may indicate whether the second and third signals respectively are authoritative over the primary bus 130, the secondary bus 131, both busses 130, 131, or neither bus. Thus the subsystem 105 may arbitrate signals from any other subsystem 110, 115, 120.

FIG. 4 illustrates example arbitration logic for the primary and secondary master values based on the authoritative information in the master values and whether the data in either or both of the first signals are aged. The logic results in one of four states for the subsystem 105: the first signal is authoritative on both communication buses 130, 131 (“Both”), the first signal is authoritative on primary communication bus 130 (“Primary”), the first signal is authoritative on the secondary communication bus 131 (“Secondary”), and the first signal is authoritative on neither communication bus (“None”). The chart of FIG. 3 lists the possibilities for the arbitration states of the failsafe devices.

In one example, the master value may indicate that the first signal is authoritative on both the primary bus 130 and the secondary bus 131. If the first signals from both the primary network path and the secondary network path are not aged, then the arbitrated state is “Both”, i.e., the first signal is authoritative on both the primary bus 130 and the secondary bus 131.

In another example, the first signals may be authoritative on both the primary bus and the secondary bus 131. If the first signal from the second network path is aged, however, then the arbitrated state is “Primary”, i.e., the first signal is authoritative on only the primary bus 130. Alternatively, if the first signal on the first network path indicates authority on both buses 130, 131, and the first signal on the second network path indicates authority on only the primary bus 130, then the arbitrated state is still “Primary.” That is, if the master value indicates that the first signal is authoritative on only one of the buses 130, 131, then the arbitrated state will reflect that one bus.

In yet another example, the first signals may be authoritative on both the primary bus 130 and the secondary bus 131, but the first signal from the first network path is aged. Here, the arbitrated state is “Secondary”, i.e., the first signal is authoritative only on the secondary 130. Alternatively, if the master value on one of the network paths indicates authority on both 130, 131 and the master value on the other network path indicates authority only on the secondary bus 131, then the arbitrated state is still “Secondary.”

In yet another example, if the master value on the first network path indicates authority on the primary bus 130, and the master value on the second network path indicates authority on the secondary bus 131, then the arbitrated state is “None”, i.e., the first signal is authoritative on neither bus 130, 131. That is, if the master values along the network paths indicate only one of the buses 130, 131 and each indicate a different one of the buses 130, 131, then the arbitrated state is “None.” Alternatively, if the master value on the first network path indicates that the first signal is authoritative on the secondary bus 131, and the master value on the second network path is aged, then the arbitrated state is “None.”

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, sensor measurements, computations, processing time, communications time, etc.

Computing devices generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 200, one or more of the steps could be omitted, or the steps could be executed in a different order. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1. A vehicle subsystem, comprising:
first and second failsafe devices, having a processor and a memory, the memory storing instructions executable by the processor to transmit information; and
a first arbitration bus connecting the first and second failsafe devices, wherein the first arbitration bus transmits information between the first and second failsafe devices;
wherein the first failsafe device is programmed to communicate with a third failsafe device over a primary bus and wherein the second failsafe device is programmed to communicate with a fourth failsafe device over a secondary bus;
wherein the first failsafe device is programmed to transmit a first signal including a first master value to the third failsafe device via the primary bus and the second failsafe device is programmed to transmit a second signal including a second master value to the fourth failsafe device via the secondary bus,
wherein the first master value and the second master value each indicate one of:
the first signal on the primary bus being authoritative,
the second signal on the secondary bus being authoritative,
the first and second signals on both the primary and secondary buses, respectively, being authoritative and
neither the first and second signals on neither the primary and secondary buses, respectively, being authoritative.

2. The system of claim 1, further comprising a second arbitration bus communicatively connecting the third and fourth failsafe devices, wherein the third failsafe device is programmed to transmit the first signal to the fourth failsafe device via the second arbitration bus and the fourth failsafe device is programmed to transmit the second signal to the third failsafe device via the second arbitration bus.

3. The, system of claim 1, wherein the first failsafe device is programmed to receive a third signal with a third master value from the third failsafe device via the primary bus and the second failsafe device is programmed to receive a fourth signal with a fourth master value via the secondary bus, wherein the third master value and the fourth master value each indicate one of:
the third signal on the primary bus being authoritative,
the fourth signal on the secondary bus being authoritative,
the third and fourth signals on both the primary and secondary buses, respectively, being authoritative and
neither the third and fourth signals on neither the primary and secondary buses, respectively, being authoritative.

4. The system of claim 1, wherein the first failsafe device is powered by a first power source and the second failsafe device is powered by a second power source.

5. The system of claim 1, wherein the subsystem is one of an autonomous vehicle control subsystem, a powertrain subsystem, a brake subsystem, a steering subsystem, and a lighting subsystem.

6. The system of claim 1, wherein the third and fourth failsafe devices are included a second vehicle subsystem.

7. The system of claim 1, wherein the third failsafe device is programmed to determine whether the first signal is aged and the fourth failsafe device is programmed to determine whether the second signal is aged.

8. The system of claim 7, wherein the third failsafe device is programmed to indicate that the first signal is not authoritative on the primary bus when the first signal is aged and the fourth failsafe device is programmed to indicate that the second signal is not authoritative on the secondary bus when the second signal is aged.

9. The system of claim 1, wherein the third and fourth failsafe devices are programmed to declare a fault when the either the first or second master values indicate that one of the first and second signals is not authoritative on one of the primary and secondary buses.

10. The system of claim 1, wherein the first and second failsafe devices are each programmed to arbitrate both the first and second master values.

11. A method, comprising:
transmitting a first signal including a first master value from a first failsafe device to a third failsafe device via a primary bus and transmitting a second signal including a second master value from a second failsafe device to a fourth failsafe device via a secondary bus,
wherein the first master value and the second master value each indicate one of:
the first signal on the primary bus being authoritative,
the second signal on the secondary bus being authoritative,
the first and second signals on both the primary and secondary buses, respectively, being authoritative and
neither the first and second signals on neither the primary and secondary buses, respectively, being authoritative.

12. The method of claim 11, further comprising a second arbitration bus communicatively connecting the third and fourth failsafe devices, wherein the third failsafe device transmits the first signal to the fourth failsafe device via the second arbitration bus and the fourth fail safe device transmits the second signal to the third failsafe device via the second arbitration bus.

13. The method of claim 11, further comprising:
receiving a third signal with a third master value transmitted from the third failsafe device to the first failsafe device via a third network path that includes the primary bus and a fourth network path that includes the first and second arbitration buses and the secondary bus, wherein the third master value indicates one of:
the third signal on the primary bus being authoritative,
the fourth signal on the secondary bus being authoritative,
the third and fourth signals on both the primary and secondary buses, respectively, being authoritative and
neither the third and fourth signals on neither the primary and secondary buses, respectively, being authoritative.

14. The method of claim 11, wherein the first failsafe device is powered by a first power source and the second failsafe device is powered by a second power source.

15. The method of claim 11, wherein the subsystem is one of an autonomous vehicle control subsystem, a powertrain subsystem, a brake subsystem, a steering subsystem, and a lighting subsystem.

16. The method of claim 11, wherein the d and fourth failsafe devices are included in a second vehicle subsystem.

17. The method of claim 11, further comprising determining whether the first signal is aged with the third failsafe device and determining whether the second signal is aged with the fourth failsafe device.

18. The method of claim 17, further comprising indicating with the third failsafe device that the first signal is not authoritative on the primary bus when the first signal is aged and indicating with the fourth failsafe device that the second signal is not authoritative on the secondary bus when the second signal is aged.

19. The method of claim 11, further comprising declaring a fault with one of the third and fourth failsafe devices when the either the first or second master values indicate that one of the first and second signals is not authoritative on one of the primary and secondary buses.

20. The method of claim 11, further comprising arbitrate both the first and second master values with one of the first and second failsafe devices.
